(19) United States
(12) Patent Application Publication
(10) Pub. No.: US 2017/0191602 A1
(43) Pub. Date: Jul. 6, 2017

(54) PLASTIC CAP DESIGN FOR PROTECTING CONNECTORS, ADAPTABLE TO DIFFERENT SIZES

(71) Applicant: Luis Alejandro AMATO MARTINEZ GARZA, Distrito Federal (MX)

(72) Inventor: Luis Alejandro AMATO MARTINEZ GARZA, Distrito Federal (MX)

(21) Appl. No.: 15/315,101

(22) PCT Filed: Jun. 2, 2014
(86) PCT No.: PCT/MX2014/000083

§ 371 Date: Nov. 30, 2016

(51) Int. Cl. F16L 57/00; B65D 59/08; B65D 59/06

(52) U.S. Cl. CPC F16L 57/00; B65D 59/06; B65D 59/08

(57) ABSTRACT

A lid to protect connectors of hydraulic and gasoline lines during its transportation, that has the ability to expand and adapt itself to many different connectors with different shapes and sizes, but still keeping its ability to remain properly installed during its working life, and at the same time to be able to be removed from the connector whenever necessary, as long as it is used within its designed rage of performance. The lid is different from all the existing connectors in the actual state of the art, which can only be used with the specific connector they were designed for.

### CROSS-REFERENCE TO RELATED APPLICATION

This application is the U.S. national phase of PCT Application No. PCT/MX2014/000083 filed on Jun. 2, 2014, the disclosure of which is incorporated in its entirety by reference herein.

### TECHNICAL FIELD

Mainly automotive connector.

### BACKGROUND

State of the art: Within the automotive industry, the metallic tubular lines to conduct the barking hydraulic fluids and gasoline are normally fabricated in different industrial facilities, away from the final assembly plants; therefore, these lines have to be transported from the factory where they have been fabricated, to the final assembly plants.

Given the fact that these lines are considered as high security items in the car for the nature of it usage, it is indispensable that the lines remain completely clean for the transportation stage, and since all these lines have connectors with threads at each end, these connectors have to be covered with dedicated plastic disposable lids to protect the threads, but mainly to avoid the potential introduction of dust or particles, that may jeopardize its correct use, or even worst, endanger the safe operation of the vehicle and the wellbeing of its occupants.

The actual result of this need is that there are thousands of different dedicated designs to cover all the different connectors. Each different connector represents a specific part number; therefore the logistics to properly manage all these different material is large and complex. All this complexity could be minimized if a single lid design could cover a range of different forms and sizes, and not just one specific connector.

All the lid that are in existence today are design with a cylindrical main section, which is the section in charge to cover and protect the connector, but at the same time this main body is in change to contain all the necessary interferences to generate the grip which will the lid in place once it has been installed over the connector to protect it.

These interferences included inside the main body of the lids, are typically longitudinal and transversal ribs and nerves formed by flexible and slim geometries that allow them to be deformed at the moment of the introduction of the connector into the lid, generating at the same time the necessary anchoring system of the lid to the connector. This implies that the main body form of each lid typically reproduces the form of the specific connector that it will cover, to allow the anchoring ribs and nerves to be kept as shorter as possible, in order to insure that the lid remains always in position during the transporting phases of the lines.

The specific geometry of these type of lids in principal is always the same, composed by a main circular body which adapts it forms and shapes to the ones of the specific connector that it will protect, and on one end of the lid it has the opening to receive the connector, while at the other end it will be closed and it will be required to have the necessary means to allow the operator to generate a proper grip to remove the lid from the connector manually and with relative ease.

### SUMMARY

This invention is about a lid that instead of resembling the geometry of the specific connector to protect, has been designed with a generic geometry that allows it to adapt to any form and geometry of connector, as long as the connector is within the range of dimensions that the lid has been designed for.

### BRIEF DESCRIPTION OF THE DRAWINGS

FIG. 1 shows an isometric view of the lid,

FIG. 2 shows a lateral view of the lid, including the basic description of its principal components,

FIG. 3 shows a plant view of the lid,

FIG. 4 shows a second plant view of the lid, similar to FIG. 3, but this one including 2 darker circles; these two darker circles represent the range of connector diameters that the lid would be able to adequately perform, with the smaller darker circle represents the minimum diameter to generate enough interference between the connector and the undulated main body of the lid, in order to generate the necessary grip to keep the lid in place without leaving its working position, the larger darker circle represents the maximum diameter that the main body of the lid can expand to cover connectors of larger diameters, and

FIG. 5 is a design of the same lid with small differences on the main body which is not completely cylindrical but triangular, and has 3 main reinforces at the exterior tips of the triangle.

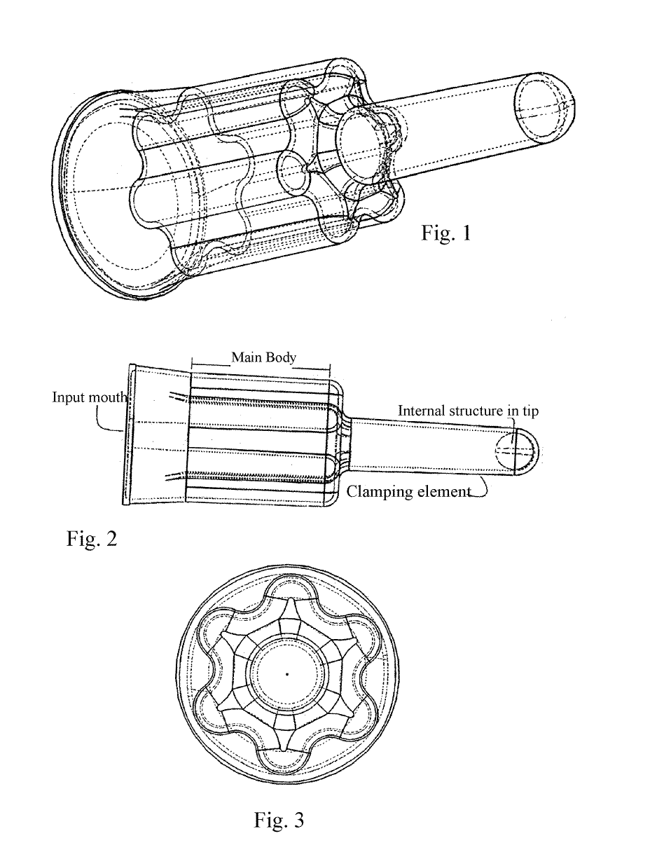

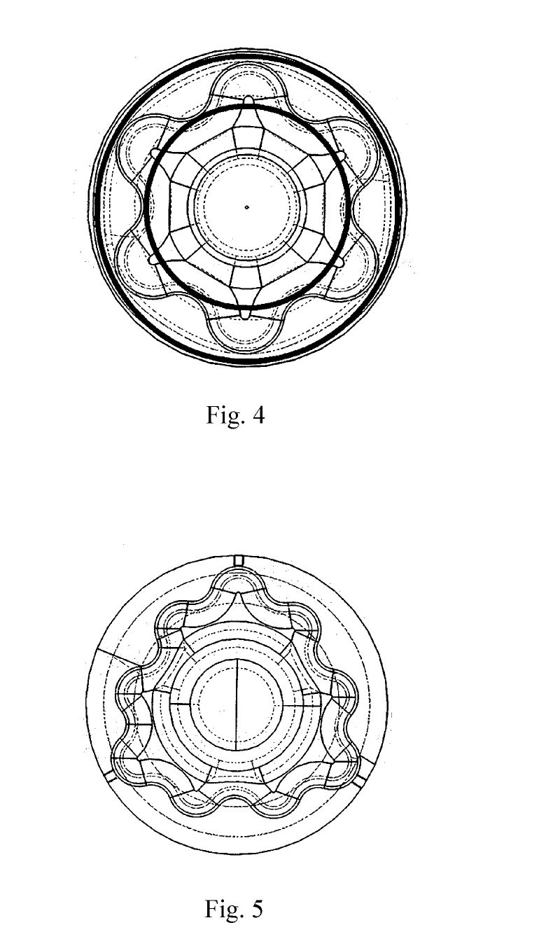

### DETAILED DESCRIPTION

As it was previously explained, the three principal objects to be covered by the lids in this application are:

1) to be able to cover and protect the connectors,

2) to generate enough interference between the connector and the lid, to warranty that the lid remains in place and fulfills its task, and

3) that it has all the necessary means to allow the operator to removed it from the connector with relative ease.

The lid of the present invention has a main principal body made of the same semi-rigid material of that one used by the majority of the actual lids in the industry, but its geometry is not any longer a basic cylindrical shape that resembles that of the specific connector to cover, but instead is a main body composed by an undulated geometry that can be cylindrical or triangular, that allows the main body to expand as necessary to be able to cover connector with dimensions from the minimum diameter of interference, to the maximum diameter of its range, which is one defined by the outside diameter of its opened end.

The main principal body of the lid of this invention it's generated by a circular or semicircular (triangle as the FIG. 5, as an example) that it is composed by continues series of undulations, allowing it to expand itself all the necessary to cover connectors of different diameters and shapes within its predefined range.

Within the FIG. 2 it is shown an element which extends from the main body and away from it, at the opposite end to the opened end of the main body; this element is named “gripping extension”. This gripping extension is formed by a slim deformable circular body that has at the very end a rigid and bulky structure that is not deformable; therefore allowing the operator to generate an anchor with the necessary grip, to be able to remove the lid with relative ease.

The fingers of the operator will press the circular flexible body of the gripping extension, that it is as flexible as the main lid body, so it can be easily deformable, but the internal rigid structure at the farthest tip of the gripping extension will not deform, thus creating an anchor to generate the required grip to remove the lid form the connector, overcoming any possibility of encountering any slippery situation.

This structure at the furthest tip of the gripping extension allows the lid a design than can be fabricated by the simplest design of plastic injection molds there are: simple opening without any lateral action in the mold, even though the majority of the lids in the industry that have a tridimensional gripping extension, require complex mold designs with lateral actions: therefore giving to the lid of this invention an important competitive edge.

The advantages mentioned in the previous paragraph are mainly that simple opening molds can accommodate a larger number of cavities, and they can have typically faster cycles than those molds that require lateral action. Also they have longer life and less maintenance needs than those molds with lateral action, since they have less moving parts. All these advantages together create for the lid of this invention a sensitive competitive edge against the majority of the lids composed by the previous state of the art.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A plastic lid for the protection of connectors comprising:
a semi-rigid undulated main body capable of expending and adapting itself to different designs and sizes of connectors.

2. The plastic lid for the protection of connectors further comprising:
a semi-rigid undulated main body capable of expending and adapting itself to different designs and sizes of connectors, including a gripping extension that allows the connector to be injected and extracted from a simple opening mold without lateral action.
